(19) United States
(12) Patent Application Publication
(10) Pub. No.: US 2025/0267742 A1
(43) Pub. Date: Aug. 21, 2025

(54) METHODS AND APPARATUS FOR SESSION MANAGEMENT FOR A DUALSTEER DEVICE

(71) Applicant: Cable Television Laboratories, Inc., Louisville, CO (US)

(72) Inventors: Omkar Shripad Dharmadhikari, Lakewood, CO (US); Arun S. Yerra, San Ramon, CA (US); Rahil Gandotra, Boulder, CO (US); Yunjung Yi, Vienna, VA (US)

(21) Appl. No.: 19/054,242

(22) Filed: Feb. 14, 2025

Related U.S. Application Data
(60) Provisional application No. 63/554,848, filed on Feb. 16, 2024.

(51) Int. Cl. H04W 76/15; H04W 84/04

(52) U.S. Cl. CPC H04W 76/15; H04W 84/042

(57) ABSTRACT

Methods and apparatus for session management for a DualSteer device are provided herein. A user equipment (UE) transmits first information indicating that the UE requests access to two Third Generation Partnership Project (3GPP) access networks simultaneously and that the UE supports access to two 3GPP access networks simultaneously. Further, the UE receives second information indicating rules for accessing the two 3GPP access networks simultaneously. Moreover, the UE transmits data using a multi-access (MA) protocol data unit (PDU) session based on the rules for accessing the two 3GPP access networks simultaneously, where the MA PDU session is established on a first 3GPP access network and a second 3GPP access network. Additionally or alternatively, the first information is included in a PDU session establishment request message. Additionally or alternatively, the second information is included in a PDU session establishment accept message. Additionally or alternatively, the UE is a DualSteer UE.

### CROSS-REFERENCE TO RELATED APPLICATIONS

This application claims the benefit of U.S. Provisional Application No. 63/554,848, filed Feb. 16, 2024, the contents of which are incorporated herein by reference.

### BACKGROUND

A multi-access-protocol data unit (MA PDU) session is a PDU session associated with two independent tunnels between a PDU session anchor (PSA) and an access node (AN) of a radio access network (RAN), and with multiple access types. For example, the MA PDU may be associated with a Third Generation Partnership Project (3GPP) access type and a non-3GPP access type, with both access types connected to the Fifth Generation (5G) Core (5GC). The traffic of an MA PDU session may be transferred over 3GPP access, over non-3GPP access, or over both accesses.

MA PDU is a key enabler of Access Traffic Steering, Switching and Splitting (ATSSS). An ATSSS-capable user equipment (UE) may communicate over 3GPP access, over non-3GPP access, or over both accesses.

SUMMARY

Methods and apparatus for session management for a DualSteer device are provided herein. A user equipment (UE) transmits first information indicating that the UE requests access to two Third Generation Partnership Project (3GPP) access networks simultaneously and that the UE supports access to two 3GPP access networks simultaneously. Further, the UE receives second information indicating rules for accessing the two 3GPP access networks simultaneously. Moreover, the UE transmits data using a multi-access (MA) protocol data unit (PDU) session based on the rules for accessing the two 3GPP access networks simultaneously, where the MA PDU session is established on a first 3GPP access network and a second 3GPP access network.

Additionally or alternatively, the first information is included in a PDU session establishment request message. Additionally or alternatively, the second information is included in a PDU session establishment accept message. Additionally or alternatively, the UE is a DualSteer UE.

In an example, the first information includes a DualSteer request, and the second information includes a DualSteer container information element (IE). Additionally or alternatively, the DualSteer container IE includes DualSteer parameters.

Additionally or alternatively, the first information includes DualSteer indication information and DualSteer capability information. Additionally or alternatively, the second information includes the DualSteer indication information and DualSteer traffic rules information.

Additionally or alternatively, the UE is registered over the first 3GPP access network and the second 3GPP access network in the same public land mobile network (PLMN). Additionally or alternatively, the UE is registered over the first 3GPP access network and the second 3GPP access network in different PLMNs. Additionally or alternatively, the UE is registered over the first 3GPP access network or the second 3GPP access network in a PLMN.

In another example, a network node receives first information indicating that a UE requests access to two 3GPP access networks simultaneously and that the UE supports access to two 3GPP access networks simultaneously. Further, the network node sends second information indicating rules for accessing the two 3GPP access networks simultaneously. Also, the network node receives data using an MA PDU session based on the rules for accessing the two 3GPP access networks simultaneously, where the MA PDU session is established on a first 3GPP access network and a second 3GPP access network.

In an example, the network node includes an Access and Mobility Management Function (AMF). Additionally or alternatively, the network node includes a Session Management Function (SMF).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and Fifth Generation (5G) core (5GC);

FIG. 4 illustrates an example of a protocol stack for a user plane and a control plane;

FIG. 5 illustrates an example of the architecture for the case of a 5G-residential gateway (RG) connecting to the 5GC;

FIG. 6 illustrates an example of the architecture for a communication system capable of Access Traffic Steering, Switching and Splitting (ATSSS) and multi-subscriber identity module (MUSIM) communication;

FIG. 7 illustrates an example of the architecture for a communication system capable of ATSSS and MUSIM communication with a terrestrial network (TN) operator leveraging a non-TN (NTN) of a partner;

FIG. 8 illustrates an example of the architecture for a communication system capable of ATSSS and MUSIM communication with an NTN operator leveraging a TN of a partner;

FIG. 9 illustrates an example of the architecture for a communication system capable of ATSSS and MUSIM communication with an NTN operator leveraging an NTN of a partner;

FIG. 10 illustrates an example of the architecture for a communication system capable of ATSSS and MUSIM communication applicable to a non-public network (NPN);

FIG. 11 illustrates an example of the architecture for a communication system for a DualSteer multi-access-protocol data unit (MA PDU) session across a visited public land mobile network (VPLMN) and a home public land mobile network (HPLMN);

FIG. 12 illustrates an example of the architecture for a communication system for a DualSteer MA PDU session across two VPLMNs;

FIG. 13 illustrates an example of a DualSteer MA PDU session establishment procedure with an HPLMN and a VPLMN;

FIG. 14 illustrates an example of a user equipment (UE) requested PDU session establishment procedure for a DualSteer UE with simultaneous access to two Third Generation Partnership Project (3GPP) networks, using different public land mobile networks (PLMNs); and

FIG. 15 illustrates an example of a UE requested PDU session establishment procedure for a DualSteer UE with simultaneous access to two 3GPP networks, using the same PLMN.

### DETAILED DESCRIPTION

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A User Equipment (UE) may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

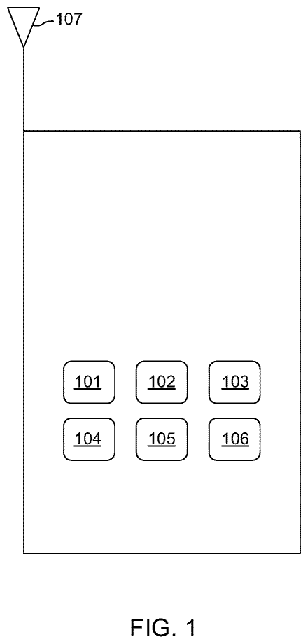

FIG. 1 is an illustration of an example device. In one case, the device may be a UE suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous, for example, different timing/spacing for uplink (UL) or downlink (DL).

Different radio access technologies may be used with one or more transceivers (e.g., 802.11, WCDMA, CDMA2000, GSM, LTE, LTE-A, LTE-A Pro, NR etc.).

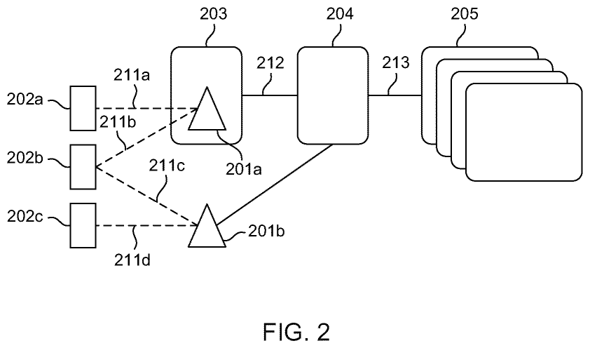

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network (CN) 204, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QOS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same radio access technology (RAT) as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMFs, one or more UPFs, one or more Session Management Functions (SMFs), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

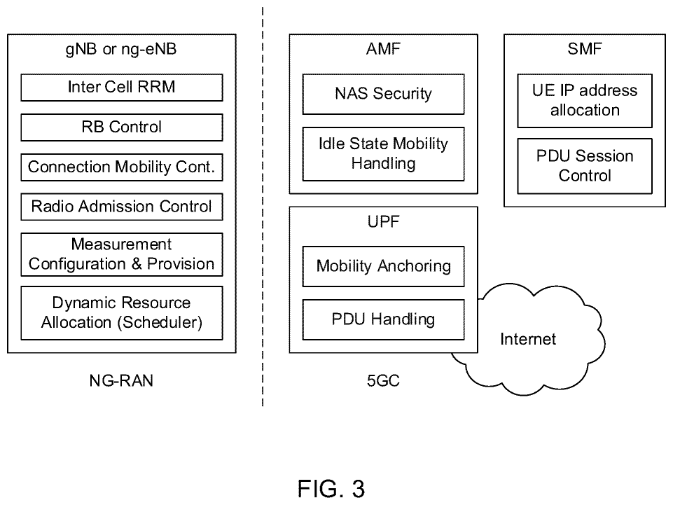

FIG. 3 illustrates an example of a functional split between the next generation radio access network (NG-RAN) and Fifth Generation (5G) core (5GC). The AMF may be connected to one or more gNB the RAN via an N2 interface and may serve as a control node. For example, the AMF may be responsible for authenticating a UE's support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

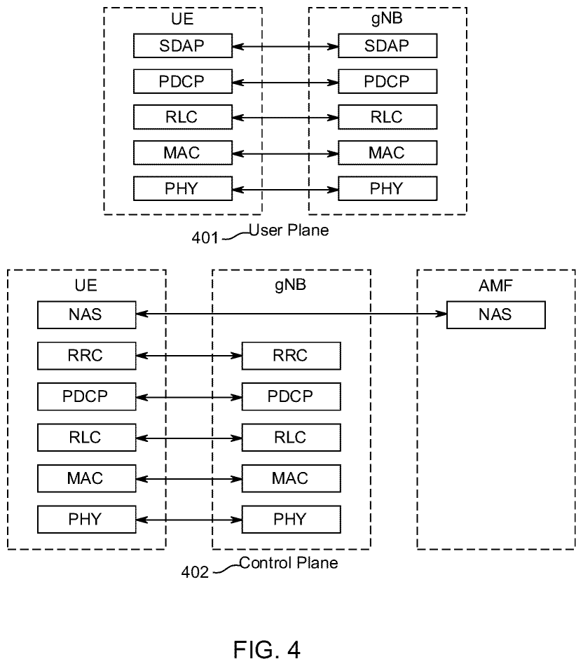

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: NAS, Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

The examples provided herein are based on the Third Generation Partnership Project (3GPP) 5G architecture and the procedures associated with the 5GC. One with ordinary skills in the art may envision other technologies being used and the same concepts may apply. Examples of other technologies may be 4G, CBRS, cdma2000, 6G, and beyond. The examples provided herein should not limit the scope of the methods.

The 3GPP standards support the access to the 5GC via a wireline access network (AN). A wireline 5G access network (W-5GAN) is a wireline AN that may connect to a 5GC. For example, devices in a home local access network (LAN), such as a residential gateway (RG), may connect to the 5GC via a Wireline Access Gateway Function (W-AGF) in the W-5GAN. The W-AGF is a network function that may interface with the 5GC Control Plane (CP) and the 5GC User Plane (UP) functions, via N2 and N3 interfaces, respectively. In the example of a home LAN, the W-AGF may provide connectivity towards the 5GC to the home LAN devices using one or more N2 and N3 interfaces with the 5GC.

A residential gateway (RG) is a device providing, for example, voice, data, broadcast video, video on demand, etc. to other devices in specific locations referred to as customer premises. In this example, an RG may have one or more processors, such as Central Processing Units (CPUs), Graphical Process Units (GPUs), Front End Processors (FEPs), Communication Processors (CPs), Field Programmable Gate Arrays (FPGAs), Vision Processing Units (VPU), Quantum Processing Units (QPUs), Associative Processing Units (APUs), and Tensor Processing Units (TPUs); a baseband radio; one or more transceivers; one or more antennas; storage, such as HDD, SSD, NVM, RAM, ROM, memory, cache; memory controller(s), a touchscreen, and a power source. The RG may also have one or more of its functions virtualized.

An RG may contain functionality that enables devices behind it to also connect with the 5GC and obtain 5G services. The devices behind the RG may be of different types, such as 3GPP-capable devices (e.g., UEs), authenticable non-3GPP (AUN3) devices, non-authenticable non-3GPP (NAUN3) devices, or non-5G-Capable over WLAN (N5CW) devices. An RG may be 5G-capable, in which case it is referred to as a 5G-RG, or it may be non-3GPP capable, in which case it is referred to as a Fixed Network RG (FN-RG). The 5G-RG may play the role of a UE.

While reference to 5GC is mentioned to assist in explaining the concepts of this invention, the examples and techniques discussed herein are equally applicable to other generations of wireless technologies, and may interchangeable with 3G, 4G, 6G, etc.

There are benefits to both users and operators to allow RGs, and devices that are non-3GPP capable and are behind RGs, to access the 3GPP 5G 5GC. The 5GC provides several features that may be beneficial, independent of the type of access technology used by the devices accessing the network. Users may receive the benefits of the rich 5G features, and operators may have means to charge for the usage of such features.

As an example, there may be one or more procedures that enable access to the Evolved Packet Core (EPC) or the 5GC via non-3GPP RATs. One such example is a UE accessing the 5GC using WLAN.

Additionally, there may be one or more procedures for supporting access to the 5GC via a wireline AN. As an example, a home LAN may be connected to the 5GC via an RG. The RG may contain functionality that enables devices behind it to connect with the 5GC and obtain 5G services.

The 5G-RG and the W-AGF may interface with the 5GC Control Plane (CP) and the 5GC User Plane (UP) functions, via N2 and N3 interfaces, respectively. They may enable authentication, registration and packet data network (PDN) connectivity procedures associated with the devices behind the RG. They may facilitate the provisioning of differentiated services to the devices behind the RG, via the interfaces with the 5GC.

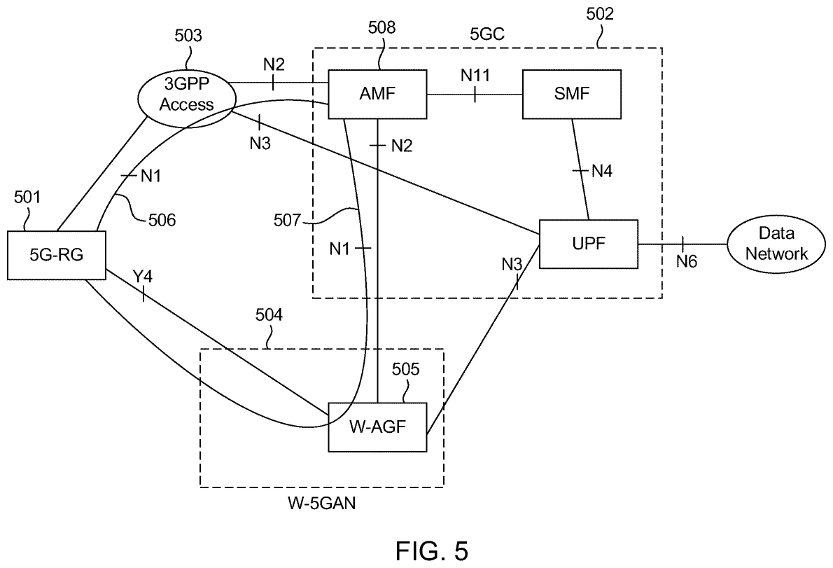

FIG. 5 illustrates an example of the architecture for the case of a 5G-RG connecting to the 5GC. As shown in an example in FIG. 5, there may be a 5G-RG 501 connecting to the 5GC (502, shown in dotted line in FIG. 5). As mentioned before, the 5G-RG 501 may be a 3GPP capable, and accordingly, it may connect to the 5GC 502 via a 3GPP access 503. An N1 link 506 may be established, via the 3GPP access 503 between the 5G-RG 501 and the 5GC 502.

At the same time, the 5G-RG 501 may connect to the 5GC 502 via a wireline access network W-5GAN (504, shown in dotted line in FIG. 5), using the W-AGF 505 functionality to interface with the 5GC 502. An N1 link 507 may be established between the 5GC 502 and the 5G-RG 501, which may transverse, transparently, through the W-AGF 507.

In the example in FIG. 5, multiple (e.g., 2) N1 links (e.g., N1 instances, N1 interfaces, N1 connections) 506, 507 may exist between the 5G-RG 501 and the 5GC 502, e.g., there may be one N1 link 506 via the 3GPP access 503 and one N1 link 507 via the W-5GAN 504. The 5G-RG 501 may be connected to a single 5GC 502, and a single AMF 508 may be connected and servicing the 5G-RG 501. The N1 link 507 between the 5G-RG 501 and the 5GC/AMF 502 may be an end-to-end link; e.g., the termination points are the 5G-RG 501 and the 5GC 502. The 5G-RG 501 supports NAS procedures and may behave as a UE. The NAS messages between the 5G-RG 501 and the 5GC 502 may be sent from the 5G-RG 501 to the W-AGF 505 via the W-CP signaling connection. The W-AGF 505 may transparently forward the message to the AMF 508. The W-AGF 505 may use an N2 Uplink NAS Transport message to forward the NAS message.

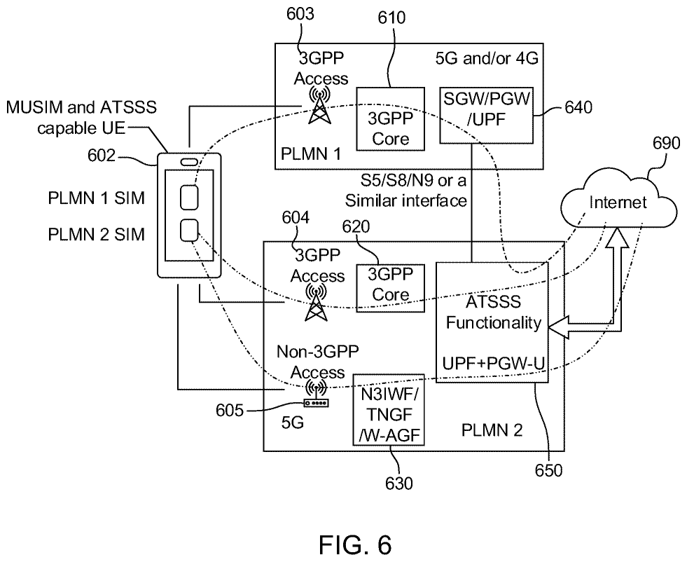

FIG. 6 illustrates an example of the architecture for a communication system capable of Access Traffic Steering, Switching and Splitting (ATSSS) and multi-subscriber identity module (MUSIM) communication. As shown in an example in FIG. 6, a UE 602 may connect to a first public land mobile network (PLMN), such as PLMN 1, and may connect to a second PLMN, such as PLMN 2. The UE 602 may be MUSIM and ATSSS capable, and may contain a PLMN 1 subscriber identity module (SIM) and a PLMN 2 SIM. The UE 602 may be 3GPP capable, and use the PLMN 1 SIM to access the 3GPP Core 610, via 3GPP access 603, and the serving gateway (SGW)/PDN gateway (PGW)/UPF 640 in the PLMN 1. The PLMN 1 may be 5G capable, 4G capable, or both.

Further, the UE 602 may use the PLMN 2 SIM to access the 3GPP Core 620, via 3GPP access 604, and the UPF+PGW-U 650 in the PLMN 2. The UPF+PGW-U 650 may include ATSSS functionality. The UE may further may use the PLMN 2 SIM to access the Non-3GPP Interworking Function (N3IWF)/Trust Non-3GPP (TNGF)/W-AGF 630, via Non-3GPP access 605, and the UPF+PGW-U 650 in the PLMN 2. The PLMN 2 may be 5G capable.

Further, data sessions across both SIMs are anchored using the UPF+PGW-U 650 in the PLMN 2, which may be the anchor network. Accordingly, the UE 602 may access the internet 690 using the PLMN 2 SIM and the UPF+PGW-U 650 in the PLMN 2, via either the 3GPP Access 604 or the non-3GPP Access 605, or via both. Additionally or alternatively, the UE 602 may further access the internet 690 using the PLMN 1 SIM and the UPF+PGW-U 650 by way of the SGW/PGW/UPF 640. Additionally or alternatively, the UPF+PGW-U 650 and the SGW/PGW/UPF 640 may be linked by an S5/S8/N9 or similar interface.

Steering, switching and splitting can be performed across SIMs camped on the same PLMN. Additionally or alternatively, steering, switching and splitting can be performed across SIMs camped on different PLMNs. Moreover, the different PLMNs may be deployed by the same or different operators. Additionally or alternatively, a PLMN may be a terrestrial network (TN) or a non-TN (NTN). Additionally or alternatively, a PLMN may be a public network or a private network. Moreover, if the PLMNs belong to different operators, an administrative relationship may exist between the two PLMNs, such as PLMN 1 and PLMN 2.

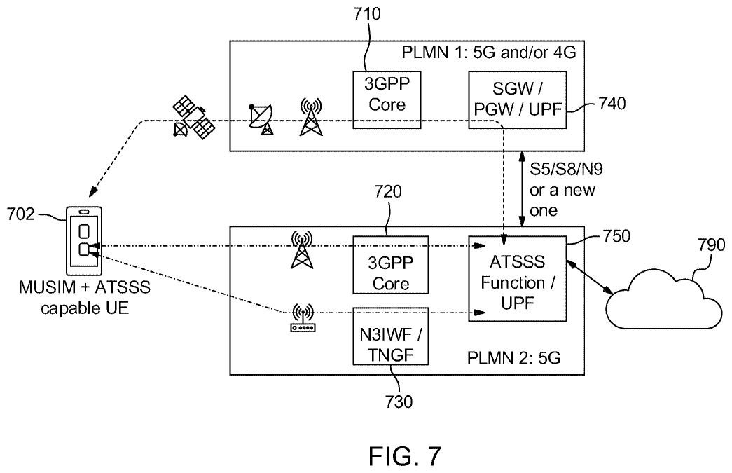

FIG. 7 illustrates an example of the architecture for a communication system capable of ATSSS and MUSIM communication with a TN operator leveraging an NTN of a partner.

As shown in an example in FIG. 7, a UE 702 may connect to an NTN PLMN 1 and may connect to a TN PLMN 2. The UE 702 may be MUSIM and ATSSS capable. The UE 702 may access the 3GPP Core 710, via 3GPP access, and the SGW/PGW/UPF 740 in the PLMN 1. The PLMN 1 may be 5G capable, 4G capable, or both.

Further, the UE 702 may access the 3GPP Core 720, via 3GPP access, and then the ATSSS Function/UPF 750 in the PLMN 2. The UE may further may access the N3IWF/TNGF 730, via non-3GPP access, and then the ATSSS Function/UPF 750 in the PLMN 2. The PLMN 2 may be 5G capable.

Also, the UE 702 may access the internet 790 using the ATSSS Function/UPF 750 in the PLMN 2, via either the 3GPP Access or the non-3GPP Access, or via both. Additionally or alternatively, the UE 702 may further access the internet 790 using the PLMN 1 and the ATSSS Function/UPF 750 by way of the SGW/PGW/UPF 740. Additionally or alternatively, the ATSSS Function/UPF 750 and the SGW/PGW/UPF 740 may be linked by an S5/S8/N9 or similar interface, or a new interface.

Moreover, steering, switching and splitting can be performed across NTNs and TNs operated by the same or different operators. Additionally or alternatively, whether PLMN 1 and PLMN 2 belong to the same or different operators may be dependent on a business agreement and enabling of an S5/S8/N9 interface.

An example shown in FIG. 7 provides flexibility to home operators in terms of switching, steering, or both splitting, between the PLMN 1 and PLMN 2. Further, this example avoids the complexity associated with seamless mobility across the two networks.

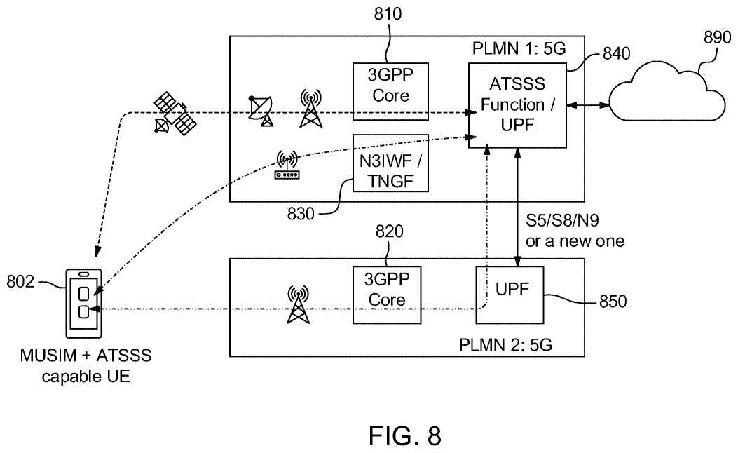

FIG. 8 illustrates an example of the architecture for a communication system capable of ATSSS and MUSIM communication with an NTN operator leveraging a TN of a partner. As shown in an example in FIG. 8, a UE 802 may connect to an NTN PLMN 1 and may connect to a TN PLMN 2. The UE 802 may be MUSIM and ATSSS capable. The PLMN 1 may be 5G capable. The UE 802 may access the 3GPP Core 810, via 3GPP access, and then the ATSSS Function/UPF 840 in the PLMN 1. The UE may further may access the N3IWF/TNGF 830, via non-3GPP access, and then the ATSSS Function/UPF 840 in the PLMN 1. The PLMN 1 may be 5G capable.

Further, the UE 802 may access the 3GPP Core 820, via 3GPP access, and the UPF 850 in the PLMN 2. The PLMN 2 may be 5G capable.

Moreover, the UE 802 may access the internet 890 using the ATSSS Function/UPF 840 in the PLMN 1, via either the 3GPP Access or the non-3GPP Access, or via both. Additionally or alternatively, the UE 802 may further access the internet 890 using the PLMN 2 and the ATSSS Function/UPF 840 by way of the UPF 850. Additionally or alternatively, the ATSSS Function/UPF 840 and the UPF 850 may be linked by an S5/S8/N9 or similar interface, or a new interface.

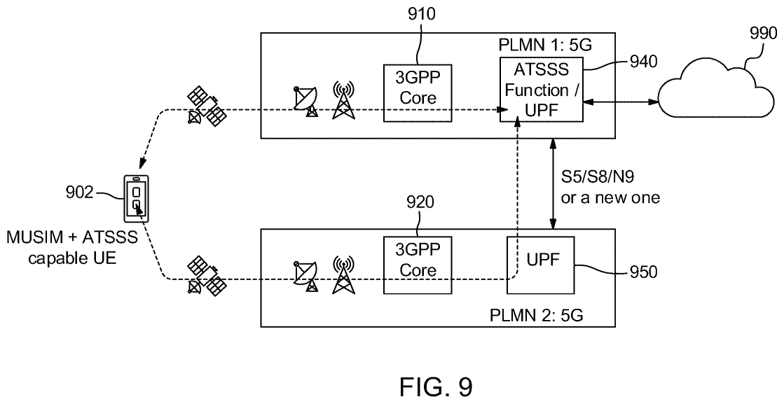

FIG. 9 illustrates an example of the architecture for a communication system capable of ATSSS and MUSIM communication with an NTN operator leveraging an NTN of a partner. As shown in an example in FIG. 9, a UE 902 may connect to an NTN PLMN 1 and may connect to an NTN PLMN 2. The UE 902 may be MUSIM and ATSSS capable. The PLMN 1 may be 5G capable and the PLMN 2 may be 5G capable. The UE 902 may access the 3GPP Core 910, via 3GPP access, and then the ATSSS Function/UPF 940 in the PLMN 1. Further, the UE 902 may access the 3GPP Core 920, via 3GPP access, and the UPF 950 in the PLMN 2.

Moreover, the UE 902 may access the internet 990 using the ATSSS Function/UPF 940 in the PLMN 1. Additionally or alternatively, the UE 802 may further access the internet 990 using the PLMN 2 and the ATSSS Function/UPF 940 by way of the UPF 950. Additionally or alternatively, the ATSSS Function/UPF 940 and the UPF 950 may be linked by an S5/S8/N9 or similar interface, or a new interface.

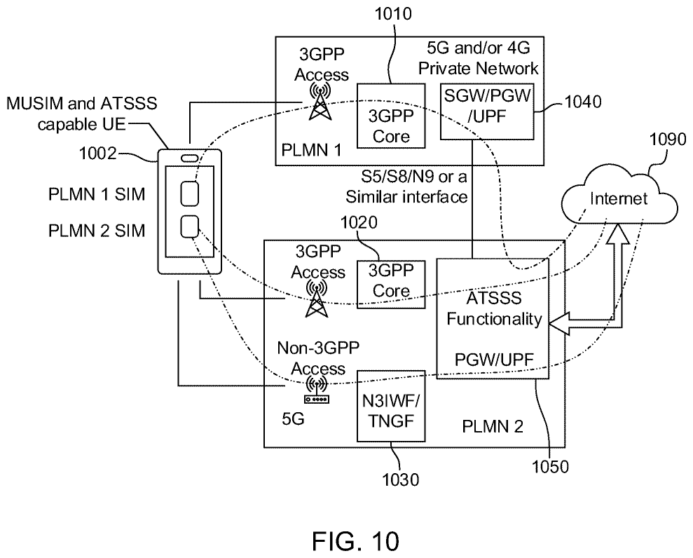

FIG. 10 illustrates an example of the architecture for a communication system capable of ATSSS and MUSIM communication applicable to a non-public network (NPN). As shown in an example in FIG. 10, a UE 1002 may connect to a PLMN 1 and to a PLMN 2. The UE 1002 may be MUSIM and ATSSS capable, and may contain a PLMN 1 SIM and a PLMN 2 SIM. The UE 1002 may be 3GPP capable, and use the PLMN 1 SIM to access the 3GPP Core 1010, via 3GPP access, and the SGW/PGW/UPF 1040 in the PLMN 1. The PLMN 1 may be 5G capable, 4G capable, or both. Further, the PLMN 1 may be a private network.

Further, the UE 1002 may use the PLMN 2 SIM to access the 3GPP Core 1020, via 3GPP access, and the PGW/UPF 1050 in the PLMN 2. The PGW/UPF 1050 may include ATSSS functionality. The UE 1002 may further may use the PLMN 2 SIM to access the N3IWF/TNGF 1030, via Non-3GPP access, and the PGW/UPF 1050 in the PLMN 2. The PLMN 2 may be 5G capable.

Moreover, the UE 1002 may access the internet 1090 using the PLMN 2 SIM and the PGW/UPF 1050 in the PLMN 2, via either the 3GPP Access or the non-3GPP Access, or via both. Additionally or alternatively, the UE 1002 may further access the internet 1090 using the PLMN 1 SIM and the PGW/UPF 1050 by way of the SGW/PGW/UPF 1040. Additionally or alternatively, the PGW/UPF 1050 and the SGW/PGW/UPF 1040 may be linked by an S5/S8/N9 or similar interface. Accordingly, this connectivity facilitates enhanced user experience for users of the private network.

MA PDU is a key enabler of Access Traffic Steering, Switching and Splitting (ATSSS). An ATSSS-capable user equipment (UE) may communicate over 3GPP access, over non-3GPP access, or over both accesses.

A DualSteer device is a device supporting traffic steering, switching and splitting of user data, for different services, across two 3GPP access networks. The traffic steering and switching of user data may be performed simultaneously or non-simultaneously over the two 3GPP networks. Traffic steering is a procedure that selects an access network and transfers traffic over the selected access network. DualSteer traffic steering occurs when traffic of one or multiple services/applications is sent across two 3GPP access networks, including scenarios where all services use the same network connection (no simultaneous data over the two networks) or different services are steered across different networks (with simultaneous data over the two networks). Traffic switching is a procedure that moves all traffic from one access network to another access network in a way that minimizes service interruption. DualSteer traffic switching occurs when traffic of one or multiple services/applications is moved from one 3GPP access network to another. Traffic splitting is a procedure that splits the traffic of a data flow across multiple access networks. When traffic splitting is applied to a data flow, some traffic of the data flow is transferred via one access and some other traffic of the same data flow is transferred via another access. DualSteer traffic splitting occurs when traffic of a single data flow belonging to a service/application is sent across two 3GPP access networks.

A DualSteer UE is an example of a DualSteer device. Additionally or alternatively, a DualSteer device may include two DualSteer UEs.

Embodiments and examples provided herein apply to two NR/5GC accesses in two different PLMNs (including two visited PLMNs (VPLMNs) or a VPLMN and the home PLMN (HPLMN)) with each access being NR TN or NR NTN. Further, embodiments and examples provided herein apply to both DualSteer UEs capable of non-simultaneous data transmission over the two networks, and DualSteer UEs capable of simultaneous data transmission over the two networks.

Also, embodiments and examples provided herein leverages MA PDU session procedures defined for ATSSS for DualSteer. The unmodified PDU Session Establishment Procedures follow the ones defined in 3GPP TS 23.502 clauses 4.3.2.2.1 and 4.3.2.2.2. The contents of 3GPP TS 23.502 are incorporated by reference, as if fully set forth herein. These procedures are modified in embodiments and examples provided herein by adding that the DualSteer UE sends a DualSteer capability indication to the network, and the network responds with a container information element (IE), specific for DualSteer or leveraging an ATSSS container, that includes the DualSteer parameters for the UE for traffic steering, traffic switching and traffic splitting.

Moreover, embodiments and examples provided herein has no impact to the registration procedure as defined in TS 23.502 clause 4.2.2.2.2, except for indicating the DualSteer support by the network within the Registration accept message indicating support for the DualSteer feature using the 5GS network feature support IE. Within this IE, the network should indicate whether it supports ATSSS, DualSteer or both. If the network supports both, it should also indicate what the network prefers-ATSSS or DualSteer. The individual registrations across both the 3GPP access networks are independent, and the DualSteer policies and rules are applied considering network availability. Further, the contents of TR 23.700-54 are incorporated by reference, as if fully set forth herein.

An example session management solution for DualSteer using MA PDU procedures is provided herein. The example solution leverages the MA PDU session, currently defined for ATSSS, as a PDU session that provides a PDU connectivity service, which can use one access network at a time, or simultaneously one 3GPP access network and one non-3GPP access network. The MA PDU session is extended to a PDU session that provides a PDU connectivity service, which can use one access network at a time, or simultaneously one 3GPP access network and one non-3GPP access network or simultaneously two 3GPP access networks.

In the case of DualSteer, an MA PDU session can be established when the UE is registered to the same PLMN over the two 3GPP access networks or registered to different PLMNs over the two 3GPP access networks. A UE can initiate MA PDU session establishment when the UE is registered to a PLMN over either of the 3GPP access networks. Therefore, at any given time, the MA PDU session can have user-plane resources established on both 3GPP access networks, or on a single 3GPP access only.

Activating multi-access PDU connectivity service for DualSteer refers to the establishment of user-plane resources on two 3GPP accesses. If the UE is registered over both 3GPP access networks in the same PLMN, the UE initiates the UE-requested PDU session establishment procedure over a selected access. Over which access to initiate this UE-requested PDU session establishment procedure is UE implementation specific.

If the UE is registered over both 3GPP access networks in different PLMNs, the UE initiates the UE-requested PDU session establishment procedure over each 3GPP access sequentially. Over which access to first initiate the UE-requested PDU session establishment procedure is UE implementation specific.

If the UE is registered to a PLMN over only one access, either 3GPP access, the UE initiates the UE-requested PDU session establishment procedure over this access. When the UE at a later point in time registers over the other 3GPP access, either in the same PLMN or in a different PLMN, it initiates the UE-requested PDU session establishment procedure with the same PDU session identifier (ID) over the other access in order to establish user plane resources on the other access for the MA PDU session.

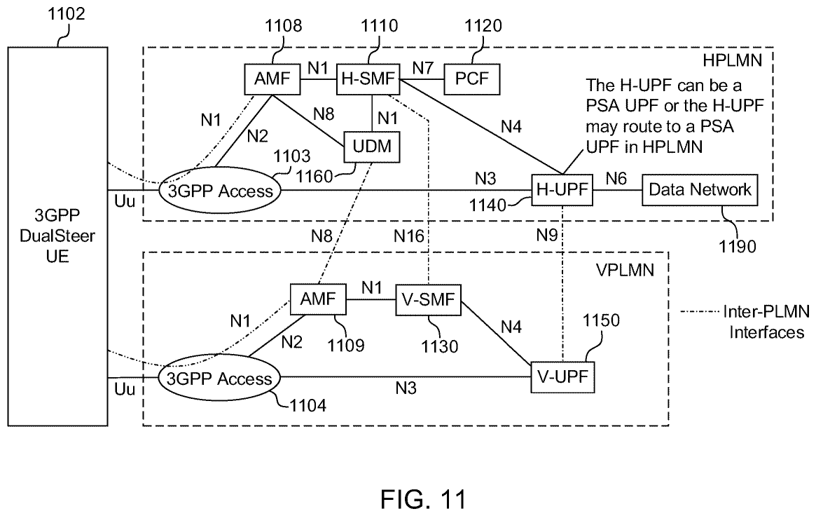

FIG. 11 illustrates an example of the architecture for a communication system for a DualSteer MA PDU session across a VPLMN and an HPLMN. FIG. 11 shows the high-level architecture envisioned for a different PLMN scenario (HPLMN and VPLMN), where the two PLMN networks are operated by different service providers. The example solution leverages the current procedures defined for Home-Routed (HR) roaming. Further, the example solution assumes that a business agreement exists between the two operators (HPLMN and VPLMN) to carry out the DualSteer procedures with access to both 3GPP networks simultaneously. The example solution includes a DualSteer MA PDU session between a DualSteer UE and a PDU session anchor (PSA) UPF across different PLMNs (HPLMN and VPLMN).

As shown in an example in FIG. 11, a DualSteer UE 1102 may connect to an HPLMN and a VPLMN. The UE DualSteer 1102 may access an AMF 1108 and the 3GPP Core, via a Uu link and 3GPP access 1103 in the HPLMN. Additionally or alternatively, the DualSteer UE 1102 may access an AMF 1109 and the 3GPP Core, via a Uu link and 3GPP access 1104 in the VPLMN.

In the HPLMN, the DualSteer UE 1102 may also access the AMF 1108 via an N1 link. Further, the AMF 1108 may connect with 3GPP access 1103 via an N2 link. Additionally, the AMF 1108 may connect with a home-SMF (H-SMF) 1110 via an N1 link. Also, the AMF 1108 may connect with a UDM 1160 via an N8 link. In addition, the H-SMF 1110 may connect with the UDM 1160 via an N1 link. Further, the H-SMF 1110 may connect with a policy control function (PCF) 1120 via an N7 link.

Moreover, the H-SMF 1110 may connect with a home-UPF (H-UPF) 1140 via an N4 link. The H-UPF 1140 can be a PSA UPF, or the H-UPF 1140 may route to a PSA UPF in HPLMN. For example, H-UPF 1140 may connect with visited-UPF (V-UPF) 1150 via an N9 link, which may be an inter-PLMN interface.

Further, the UE 1102 may access a data network 1190 using the H-UPF 1140 and an N6 link, via either the various connectivity described above to reach the H-UPF 1140, or via 3GPP Access 1103 connected to the H-UPF 1140 via an N3 link.

Also, the UDM 1160 in the HPLMN may connect with the AMF 1109 in the VPLMN via an N8 link, which may be an inter-PLMN interface. Moreover, the H-SMF 1110 may connect with a visited-SMF (V-SMF) 1130 via an N16 link, which may be an inter-PLMN interface.

In the VPLMN, the DualSteer UE 1102 may also access the AMF 1109 via an N1 link. Further, the AMF 1109 may connect with 3GPP access 1104 via an N2 link. Additionally, the AMF 1109 may connect with the V-SMF 1130 via an N1 link. As noted above, the AMF 1109 may connect with a UDM 1160 via an N8 link. In addition, the H-SMF 1110 may connect the V-UPF 1150 via an N4 link. Moreover, the DualSteer UE 1102 may also access the V-UPF 1150 via 3GPP access 1104, which is connected to the V-UPF 1150 by an N3 link.

As shown in the connectivity above, the HPLMN contains the PSA UPF. Accordingly, the above example shows a DualSteer MA PDU session between DualSteer UE 1102 and a PSA UPF across different PLMNs.

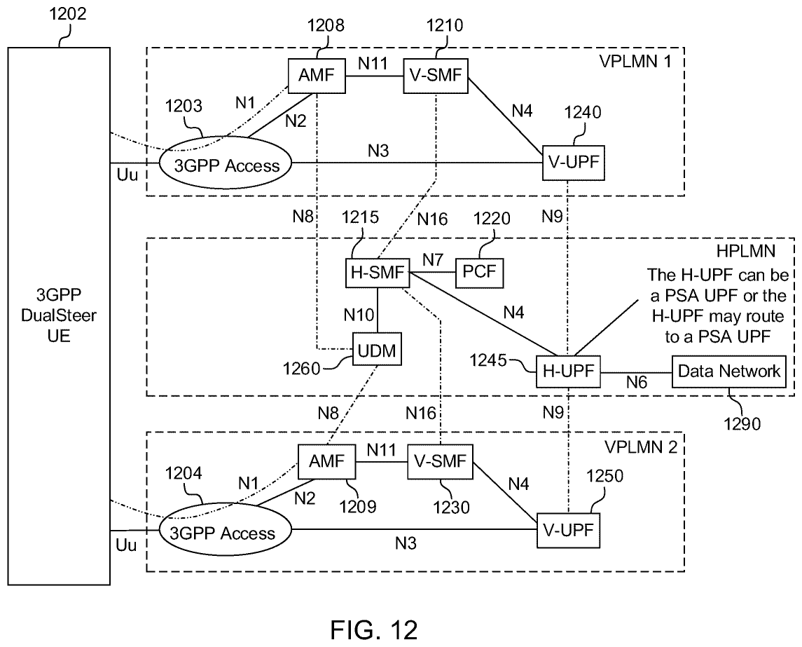

FIG. 12 illustrates an example of the architecture for a communication system for a DualSteer MA PDU session across two VPLMNs. FIG. 12 shows the high-level architecture envisioned for different PLMN scenario (two VPLMNs) where the HPLMN and the two VPLMN networks are operated by different service providers. The example solution leverages the current procedures defined for HR roaming. The example solution assumes that a business agreement exists between the operators (HPLMN and VPLMN(s)) to carry out the DualSteer procedures with access to both 3GPP networks simultaneously. The example solution includes a DualSteer MA PDU session between a DualSteer UE and a PSA UPF across different PLMNs (two VPLMNs).

As shown in an example in FIG. 12, a DualSteer UE 1202 may connect to a VPLMN 1 and a VPLMN 2. The UE DualSteer 1202 may access an AMF 1208 and the 3GPP Core, via a Uu link and 3GPP access 1203 in the VPLMN 1. Additionally or alternatively, the DualSteer UE 1202 may access an AMF 1209 and the 3GPP Core, via a Uu link and 3GPP access 1204 in the VPLMN 2.

In the VPLMN 1, the DualSteer UE 1202 may also access the AMF 1208 via an N1 link. Further, the AMF 1208 may connect with 3GPP access 1203 via an N2 link. Additionally, the AMF 1208 may connect with a V-SMF 1210 via an N11 link. The V-SMF 1210 may connect with a V-UPF 1240 via an N4 link. Moreover, the DualSteer UE 1202 may also access the V-UPF 1240 via 3GPP access 1203, which is connected to the V-UPF 1240 by an N3 link.

Similarly, in the VPLMN 2, the DualSteer UE 1202 may also access the AMF 1209 via an N1 link. Further, the AMF 1209 may connect with 3GPP access 1204 via an N2 link. Additionally, the AMF 1209 may connect with a V-SMF 1230 via an N11 link. The V-SMF 1230 may connect with a V-UPF 1250 via an N4 link. Moreover, the DualSteer UE 1202 may also access the V-UPF 1250 via 3GPP access 1203, which is connected to the V-UPF 1250 by an N3 link.

Further, the AMF 1208 in VPLMN 1 and the AMF 1209 in VPLMN 2 may connect with a UDM 1260 in an HPLMN via N8 links, which may be inter-PLMN interfaces. In addition, the H-SMF 1215 in the HPLMN may connect with the UDM 1260 via an N10 link. Further, the H-SMF 1215 may connect with a PCF 1220 via an N7 link. Further, the V-SMF 1210 and the V-SMF 1230 may connect with the H-SMF 1215 via N16 links, which may be inter-PLMN interfaces.

Further, the H-SMF 1215 may connect with an H-UPF 1245 via an N4 link. The H-UPF 1245 can be a PSA UPF, or the H-UPF 1140 may route to a PSA UPF. In an example, the PSA UPF may be in the HPLMN. For example, H-UPF 1245 may connect with V-UPF 1240 and with V-UPF 1250 via N9 links, which may be inter-PLMN interfaces.

Moreover, the UE 1202 may access a data network 1290 using the H-UPF 1245 and an N6 link, via the various connectivity described above to reach the H-UPF 1245. As shown in the connectivity above, the HPLMN contains the PSA UPF, reached by way of VPLMN 1 or VPLMN 2. Accordingly, the above example shows a DualSteer MA PDU session between DualSteer UE 1202 and a PSA UPF across different PLMNs.

Examples provided herein define the UE Requested PDU Session Establishment Procedure for DualSteer UE with access to two 3GPP networks using different PLMNs (HPLMN and VPLMN). In the case of different PLMNs (HPLMN and VPLMN), the PDU Session Establishment procedure is initiated by the DualSteer UE across both 3GPP access networks sequentially. Over which access to first initiate the UE-requested PDU session establishment procedure is UE implementation specific.

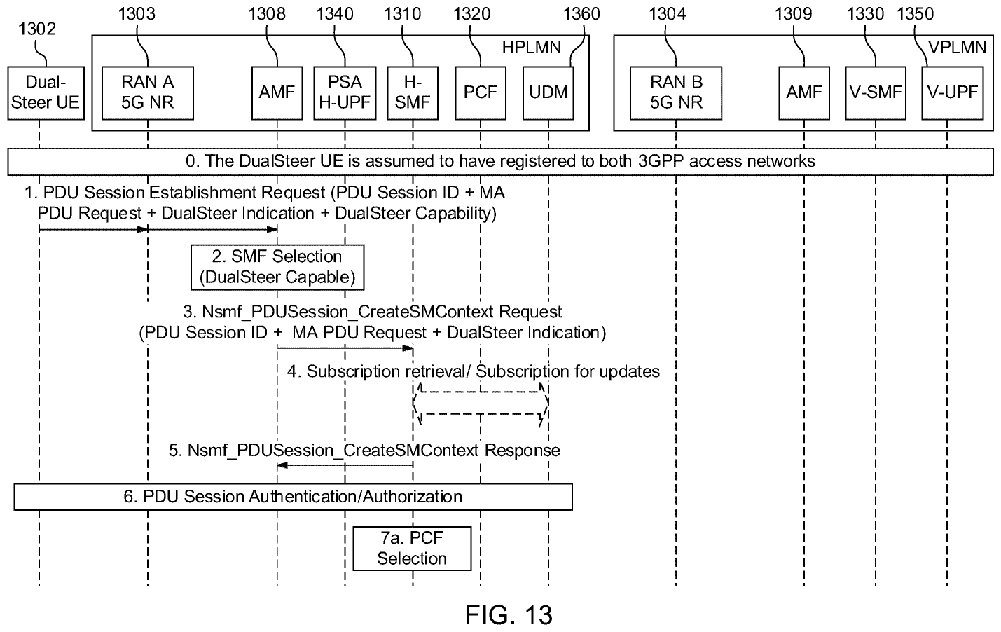

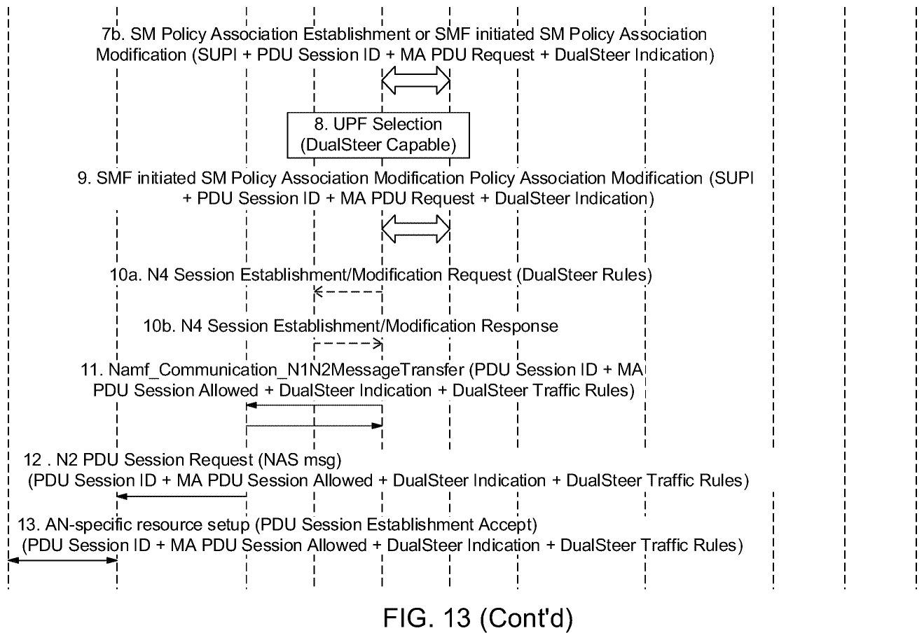

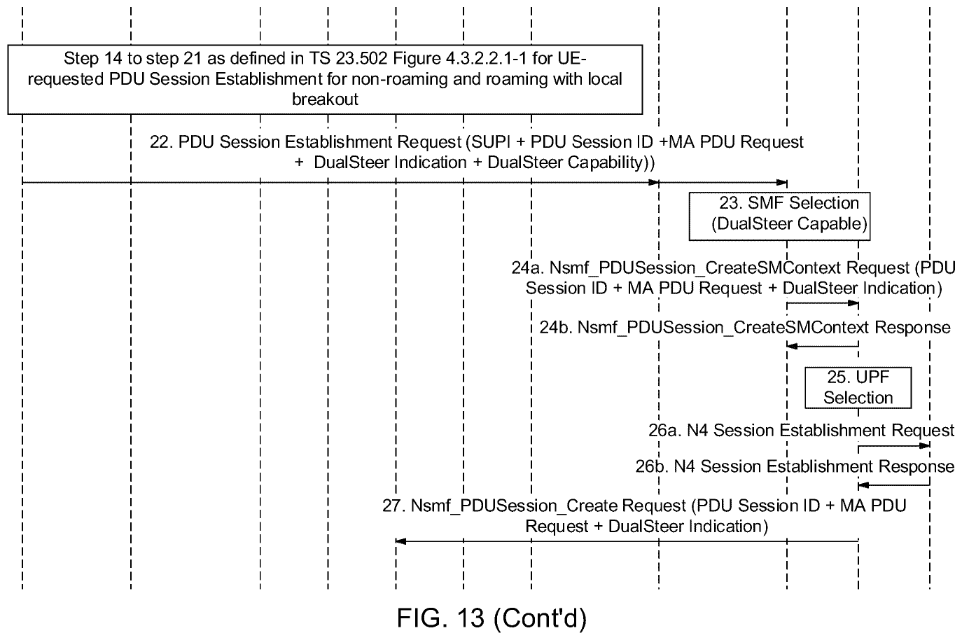

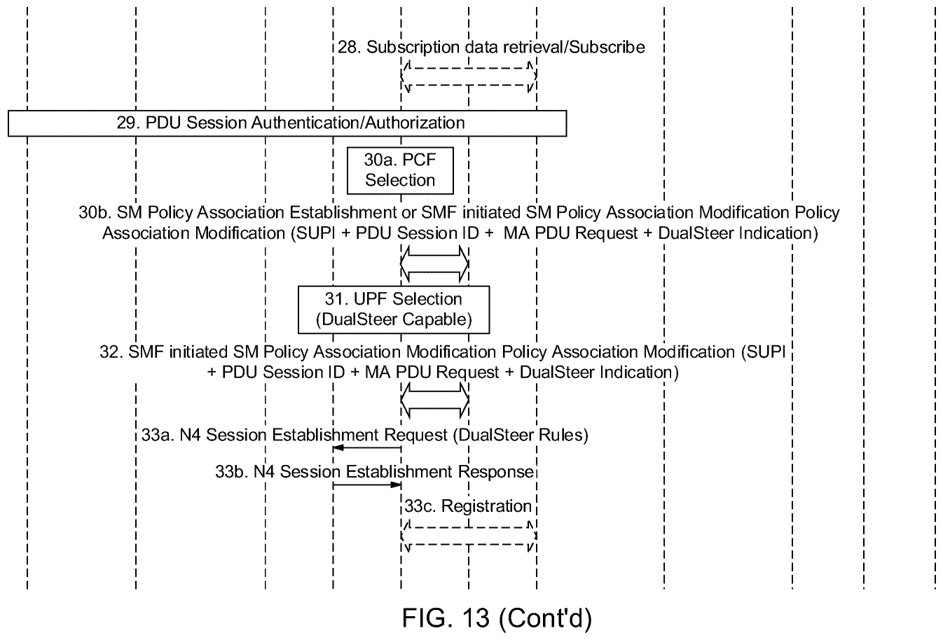

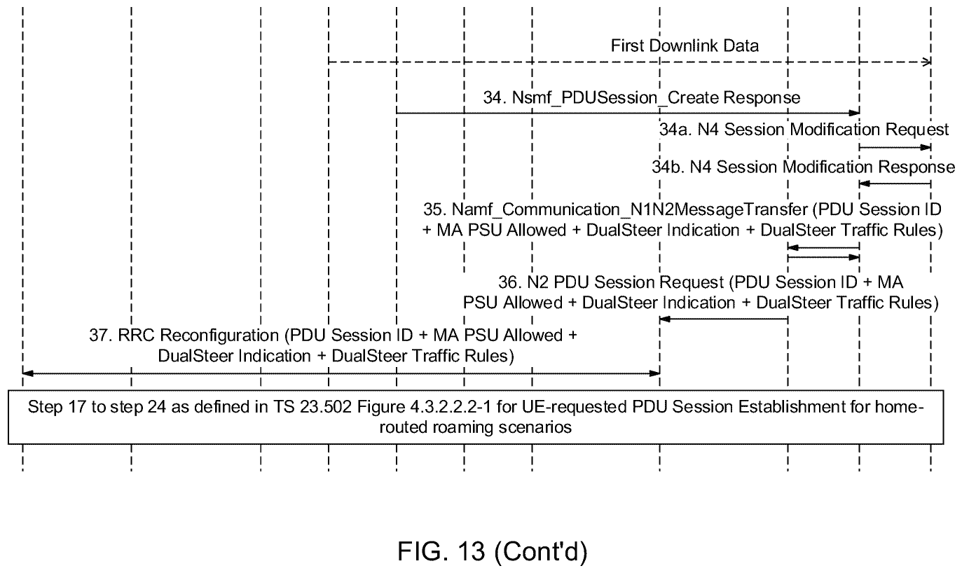

FIG. 13 illustrates an example of a DualSteer MA PDU session establishment procedure with an HPLMN and a VPLMN. As shown in an example in FIG. 13, a DualSteer UE 1302 may access two 3GPP networks using different PLMNs, a HPLMN and a VPLMN. The HPLMN includes a RAN A 5G NR node 1303, an AMF 1308, a PSA H-UPF 1340, an H-SMF 1310, a PCF 1320 and a UDM 1360. Also, the VPLMN includes a RAN B 5G NR node 1304, an AMF 1309, a V-SMF 1330 and a V-UPF 1350.

The example procedure in FIG. 13 assumes the DualSteer UE 1302 first selects the HPLMN access to initiate the UE-requested PDU session establishment procedure. The UE-requested PDU session establishment procedure on the HPLMN is based on TS 23.502 clause 4.3.2.2.1 (steps 1 to 21). The UE-requested PDU session establishment procedure on the VPLMN is based on TS 23.502 clause 4.3.2.2.2 (steps 22 to 45). If the DualSteer UE 1302 first selects the VPLMN access to initiate the UE-requested PDU session establishment procedure, the overall procedure remains the same, with steps 22 to 45 being performed before step 1 to 21. The example procedure assumes that the DualSteer UE 1302 has already registered with the AMFs 1308, 1309 in both 3GPP networks, thus unless the DualSteer UE 1302 is Emergency Registered, the AMFs 1308, 1309 have already retrieved the user subscription data from the UDM 1360. This may registration may be represented by step 0 in FIG. 13. Below are a few aspects of the example procedure that differ from the procedures in TS 23.502 clause 4.3.2.2.1 and 4.3.2.2.2.

The DualSteer UE 1302 includes the PDU Session ID and MA PDU session request within the PDU Session Establishment Request message indicating the support for DualSteer feature using the DualSteer Indication and DualSteer supported steering functionality/modes using the DualSteer Capability IEs as shown AMF in Steps 1 and 22.

For example, in the HPLMN in Step 1, the DualSteer UE 1302 transmits the PDU Session Establishment Request to the RAN B 5G NR node 1303. The RAN A 5G NR node 1303 forwards the PDU Session Establishment Request to the AMF 1308. The PDU Session Establishment Request includes not just the PDU Session ID and MA PDU Request, but also DualSteer Indication information and DualSteer Capability IEs.

Similarly, in the VPLMN in Step 22, the DualSteer UE 1302 transmits the PDU Session Establishment Request to the RAN B 5G NR node 1304. The RAN B 5G NR node 1304 forwards the PDU Session Establishment Request to the AMF 1309. The PDU Session Establishment Request includes not just the subscription permanent identifier (SUPI), PDU Session ID and MA PDU Request, but also DualSteer Indication information and DualSteer Capability IEs.

Based on the indication in Steps 1 and 22, the AMFs 1308, 1309 in both the HPLMN and VPLMN select the same DualSteer capable H-SMF, as shown in Steps 2 and 23. The AMFs 1308, 1309 then forward the MA PDU Session Request with the DualSteer Indication information within the CreateSMcontext Request message to the H-SMF 1310 in Step 3 and 27 (via the V-SMF 1330 as in Step 24a).

The H-SMF 1310 performs a session management (SM) Policy Association Establishment procedure to establish an SM Policy Association with the PCF 1320 in the home network (HPLMN) and is provided with the default policy and charging control (PCC) Rules for the PDU Session. This association considers the DualSteer feature support and any associated polices in Steps 7b and 30b. For example, this association considers the DualSteer indication information.

Also, as shown in Steps 9 and 32, if the H-SMF 1310 initiates an SM Policy Modification procedure for Policy Association Modification, the DualSteer feature support and any associated polices are also considered. For example, the Modification procedure considers the DualSteer indication information.

Further, at Steps 10a and 33a, the H-SMF 1310 may send an N4 session establishment/modification request to the PSA H-UPF 1340. This N4 session establishment/modification request may include DualSteer Rules, which may be DualSteer N4 Rules, in an example.

Additionally, the H-SMF 1310 includes the PDU Session ID and the DualSteer response (indicating the support for DualSteer feature and the configured DualSteer rules) to the AMF in step 11 and step 35. For example, in the HPLMN at Step 11, the H-SMF 1310 sends a Namf_Communication_N1N2MessageTransfer to the AMF 1308. The Namf_Communication_N1N2MessageTransfer includes not only the PDU Session ID and MA PDU Session Allowed information, but also DualSteer Indication information and DualSteer Traffic Rules. Similarly, in the VPLMN at Step 35, the V-SMF 1330 sends a Namf_Communication_N1N2MessageTransfer to the AMF 1309. The Namf_Communication_N1N2MessageTransfer includes not only the PDU Session ID and MA PSA Allowed information, but also DualSteer Indication information and DualSteer Traffic Rules.

The N2 PDU Session Request in steps 12 and 36, the PDU Session Establishment Accept message in step 13 and the RRC Reconfiguration message in step 37 contain the DualSteer Container IE for the DualSteer UE from the SMF. This container includes the information elements associated with DualSteer.

For example, in the HPLMN in step 12 the AMF 1308 sends an N2 PDU session request NAS message to the RAN A 5G NR 1303. This NAS message contains not just the PDU Session ID and MA PSA Allowed information, but also DualSteer Indication information and DualSteer Traffic Rules. Similarly, in the VPLMN in step 36, the AMF 1309 sends an N2 PDU session request message to the RAN B 5G NR 1304. This message contains not only PDU Session ID and MA PSA Allowed information, but also DualSteer Indication information and DualSteer Traffic Rules.

Further, in step 13, the DualSteer UE 1302 and the RAN A 5G NR 1303 may engage in AN-specific resource setup, including a PDU Session Establishment Accept. This may include not just PDU Session ID and MA PDU Session Allowed information, but also DualSteer Indication information and DualSteer Traffic Rules.

Moreover, in step 37, the DualSteer UE 1302 and the RAN A 5G NR 1303 may engage in RRC Reconfiguration. This reconfiguration may include not just PDU Session ID and MA PSU Allowed information, but also DualSteer Indication information and DualSteer Traffic Rules.

As used herein, the DualSteer container information element is a modified information element to transfer parameters associated with DualSteer. The ATSSS container information element defined for ATSSS may be re-used for carrying the DualSteer parameters. The DualSteer and ATSSS (or a common) container information element will also include information regarding which amongst DualSteer and ATSSS is preferred, assuming both are supported by the UE and the network.

Further, in step 26a, an N4 Session Establishment Request message is sent by V-SMF 1330 to V-UPF 1350. Also, in step 26b, an N4 Session Establishment Response is sent by V-UPF 1350 to V-SMF 1330. In these steps, UL N9 tunnel CN information is allocated by the H-SMF 1310 or H-UPF 1340. After this, N9 tunnels between the H-UPF 1340 and V-UPF 1350 are established. Additionally, the H-SMF 1310 selects the same DualSteer capable H-UPF 1340 and sends the DualSteer rules to the H-UPF 1340 for establishing the user plane resources in N4 session Establishment message in steps 10a and 33a, as mentioned above.

Given that both SUPIs on each of the networks (HPLMN and VPLMN) are provisioned in the UDM in HPLMN, the HPLMN may associate the two SUPIs to a common subscription profile. In case of different PLMN (two VPLMNs), the UE-requested PDU session establishment procedures are performed on both the VPLMNs as defined in TS 23.502 clause 4.3.2.2.2 (steps 22 to 45) with the same identified differences as mentioned above (for steps 22, 24b, 27, 32, 36 and 37).

As noted in FIG. 13, step 14 to step 21 may be as defined in 3GPP TS 23.502, FIG. 4.3.2.2.1-1 for a UE-requested PDU Session Establishment for non-roaming and roaming with local breakout. As further noted, step 17 to step 24 may be as defined in 3GPP TS 23.502, FIG. 4.3.2.2.1-1 for a UE-requested PDU Session Establishment for home-routed roaming scenarios.

In the examples provided herein, the AMF supports DualSteer capable SMF selection that can support session management across both 3GPP networks. Further, the SMF supports DualSteer capable PSA UPF selection that can support session management across both 3GPP accesses. Also, the SMF indicates DualSteer feature support and sends the DualSteer container IE to the UE via the AMF, including the DualSteer parameters. Additionally, the SMF maps the PCC rules into DualSteer rules which are sent to UE via the AMF.

In addition, the PCF creates PCC rules based on the specified DualSteer steering functionality. Further, the UE indicates DualSteer feature support as part of the MA PDU request to the SMF via the AMF. The UE may send information indicating that the UE supports an MA PDU session using two 3GPP access networks. For example, the UE may include DualSteer indication information and DualSteer capability information in a PDU Session Establishment Request sent by the UE to a network node.

Examples including a multi-access PDU connectivity service activation for a DualSteer UE are provided herein. As used in examples herein, activating multi-access PDU connectivity service refers to the establishment of user-plane resources on both 3GPP accesses.

If the UE is registered over both 3GPP access networks in the same PLMN, the UE shall initiate the UE-requested PDU session establishment procedure as specified in clause 6.4.1.2 of 3GPP TS 24.501 over a selected access. The contents 3GPP TS 24.501 are incorporated by reference, as if fully set forth herein. Over which access to initiate this UE-requested PDU session establishment procedure is UE implementation specific.

When the UE receives the PDU SESSION ESTABLISHMENT ACCEPT message including the DualSteer container IE, the UE shall consider that the MA PDU session has been established and the user plane resources are successfully established on the selected access. When the user plane resources are established on the access other than the selected access, the UE shall consider the user plane resources are established on both.

Further, if the UE receives the PDU SESSION ESTABLISHMENT ACCEPT message including the DualSteer container IE and fails to receive user plane resources established on the access other than the selected access, upon an implementation specific timer expiry the UE re-initiates the UE-requested PDU session establishment procedure over the access other than the selected access, in order to establish user plane resources on the access other than the selected access.

If the UE is registered over both 3GPP access networks in different PLMNs, the UE shall initiate the UE-requested PDU session establishment procedure as specified in clause 6.4.1.2 of 3GPP TS 24.501 over each 3GPP access sequentially. Over which access to first initiate the UE-requested PDU session establishment procedure is UE implementation specific. When the UE receives the PDU SESSION ESTABLISHMENT ACCEPT message including the DualSteer container IE over the selected access, the UE shall consider that the MA PDU session has been established and the user plane resources of the MA PDU session on this access are successfully established. The UE shall then initiate the UE-requested PDU session establishment procedure with the same PDU session ID over the other access, in order to establish user plane resources on the other access for the MA PDU session. If the UE receives the PDU SESSION ESTABLISHMENT ACCEPT message over the other access, the UE shall consider that the user plane resources of the MA PDU session have been established on both 3GPP access networks.

If the UE is registered to a PLMN over only one access, either 3GPP access, the UE shall initiate the UE-requested PDU session establishment procedure as specified in clause 6.4.1.2 of 3GPP TS 24.501 over this access. When the UE receives the PDU SESSION ESTABLISHMENT ACCEPT message including the DualSteer container IE over the access, the UE shall consider that the MA PDU session has been established and the user plane resources of the MA PDU session on this access are successfully established. When the UE at a later point in time registers over the other 3GPP access, either in the same PLMN or in a different PLMN, the UE shall initiate the UE-requested PDU session establishment procedure with the same PDU session ID over the other access in order to establish user plane resources on the other access for the MA PDU session. If the UE receives the PDU SESSION ESTABLISHMENT ACCEPT message over the other access, the UE shall consider that the user plane resources of the MA PDU session have been established over both 3GPP access networks.

Further, the DualSteer container information element is a modified information element to transfer parameters associated with DualSteer, as noted above. The ATSSS container information element defined for ATSSS may be re-used for carrying the DualSteer parameters.

Examples are provided herein of a PDU session establishment procedure with network modification to the MA PDU session. When a DualSteer UE capable of simultaneous data transmission over the two 3GPP networks establishes a new PDU session and the related UE route selection policy (URSP) or UE local configuration does not mandate the PDU session shall be established over a single access, one or more of the following may apply.

If the UE is registered over both 3GPP access networks in the same PLMN and the UE initiates the UE-requested PDU session establishment procedure over a selected access, either 3GPP access, the UE may include the MA PDU session information IE in the UL NAS TRANSPORT message and set the IE to “MA PDU session network upgrade is allowed” as defined in clause 9.11.3.31A of 3GPP TS 24.501. When the UE receives the PDU SESSION ESTABLISHMENT ACCEPT message including the DualSteer container IE, the UE shall consider that the requested PDU session is established as an MA PDU session and the user plane resources are successfully established on the selected access. When the user plane resources are established on the access other than the selected access, the UE shall consider the user plane resources are successfully established on both accesses.

Further, if the UE receives the PDU SESSION ESTABLISHMENT ACCEPT message including the DualSteer container IE and fails to receive user plane resources established on the access other than the selected access, upon an implementation specific timer expiry, the UE re-initiates the UE-requested PDU session establishment procedure over the access other than the selected access, in order to establish user plane resources on the access other than the selected access.

If the UE is registered over both 3GPP access networks in different PLMNs and the UE initiates the UE-requested PDU session establishment procedure over either access, the UE may include the MA PDU session information IE in the UL NAS TRANSPORT message and shall set the IE to “MA PDU session network upgrade is allowed” as defined in clause 9.11.3.31A of 3GPP TS 24.501. When the UE receives the PDU SESSION ESTABLISHMENT ACCEPT message including the DualSteer container IE over the access, the UE shall consider that the requested PDU session is established as an MA PDU session and the user plane resources are established on this access. The UE shall then initiate the UE-requested PDU session establishment procedure with the same PDU session ID over the other access, in order to establish user plane resources on the other access for the MA PDU session. If the UE receives the PDU SESSION ESTABLISHMENT ACCEPT message including the DualSteer container IE over the other access, the UE shall consider that the user plane resources of the MA PDU session have been established on both 3GPP access networks.

If the UE is registered to a PLMN over only one access, either 3GPP access, and the UE requests to establish a PDU session over this access, the UE may include the MA PDU session information IE in the UL NAS TRANSPORT message and shall set the IE to “MA PDU session network upgrade is allowed” as defined in clause 9.11.3.31A of 3GPP TS 24.501. When the UE receives the PDU SESSION ESTABLISHMENT ACCEPT message including the DualSteer container IE over the access, the UE shall consider that the requested PDU session is established as an MA PDU session and the user plane resources are established on this access. When the UE at a later point in time registers over the other access, either in the same PLMN or in a different PLMN, the UE shall initiate the UE-requested PDU session establishment procedure with the same PDU session ID over the other access in order to establish user plane resources on the other access for the MA PDU session. If the UE receives the PDU SESSION ESTABLISHMENT ACCEPT message including the DualSteer container IE over the other access, the UE shall consider that the user plane resources of the MA PDU session have been established on both 3GPP access and non-3GPP access.

Examples are provided herein of a UE requested PDU session establishment procedure for a DualSteer UE with simultaneous access to two 3GPP networks, using different PLMNs. In the case of different PLMNs, the PDU Session Establishment procedure will be initiated by the DualSteer UE across both 3GPP access networks sequentially. Over which access to first initiate the UE-requested PDU session establishment procedure is UE implementation specific.

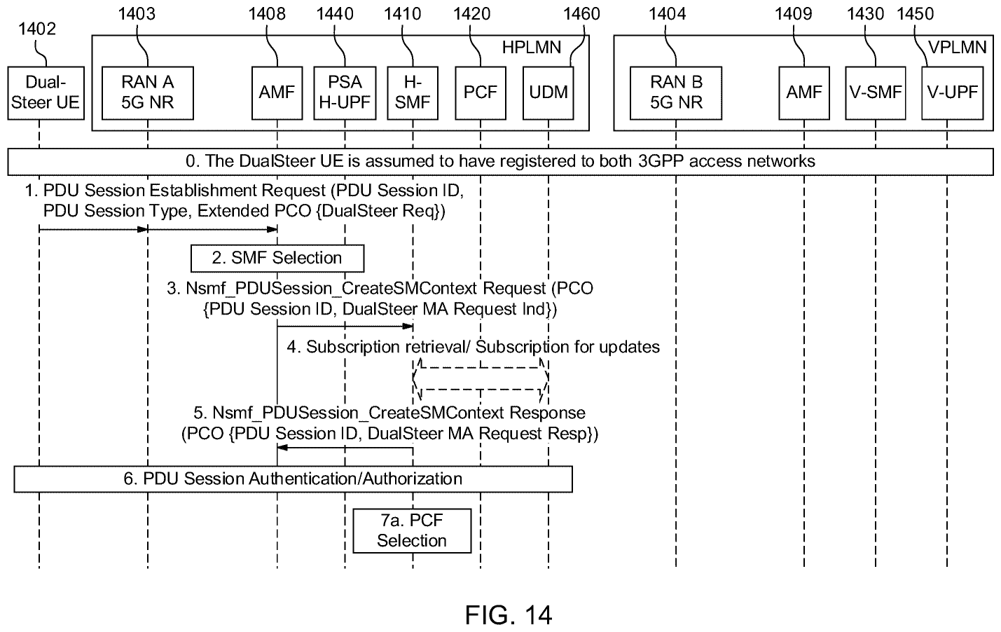

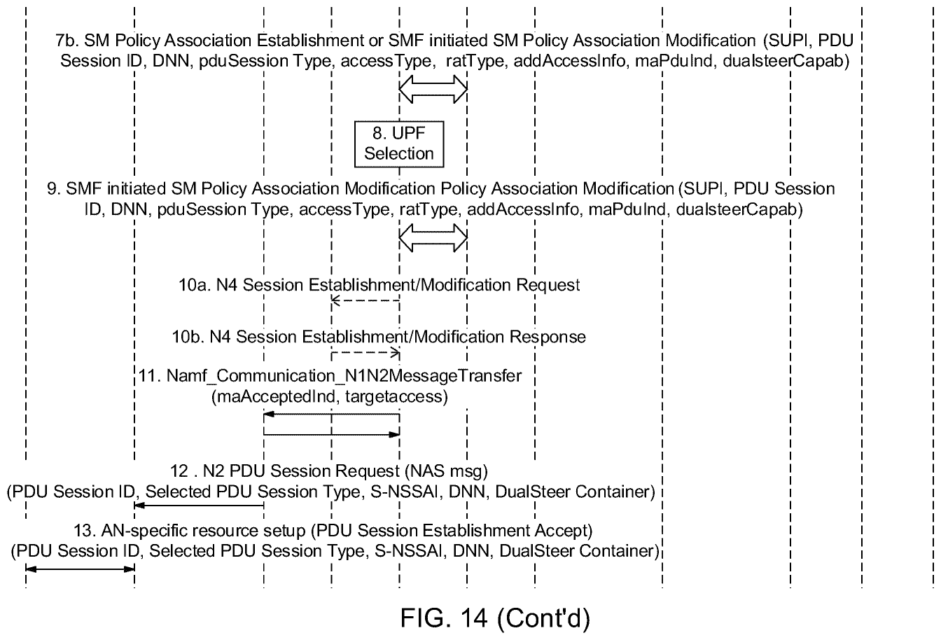

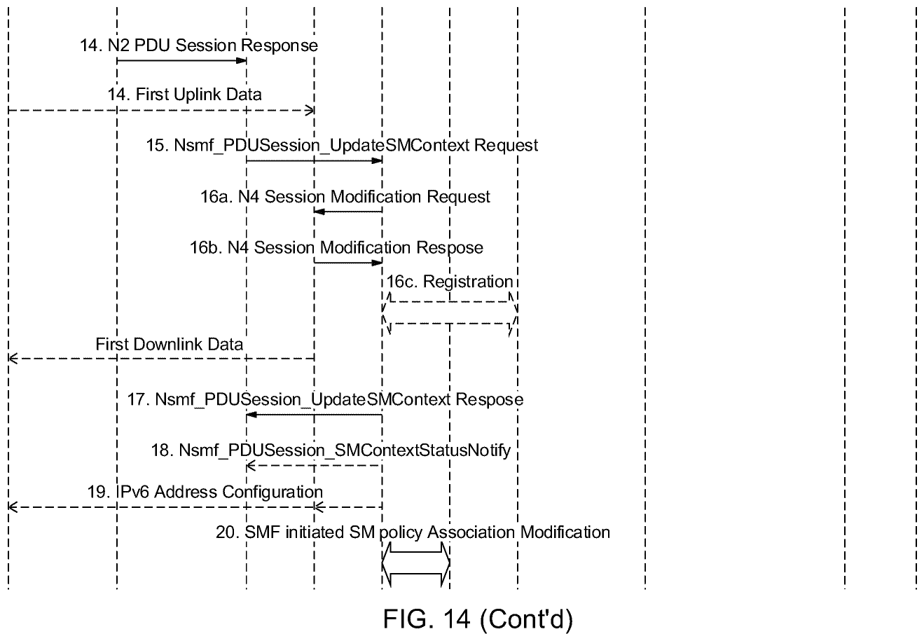

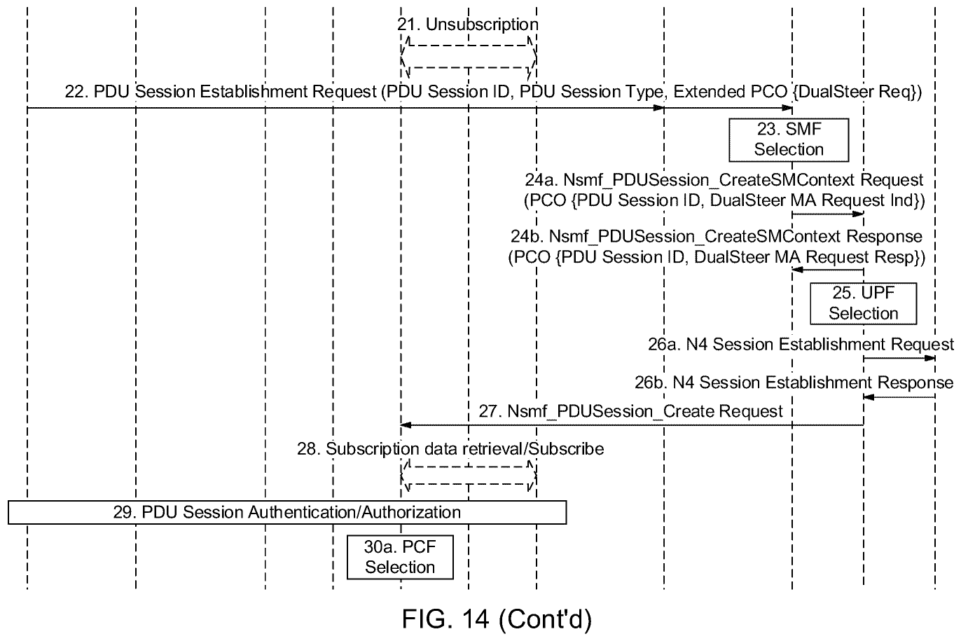

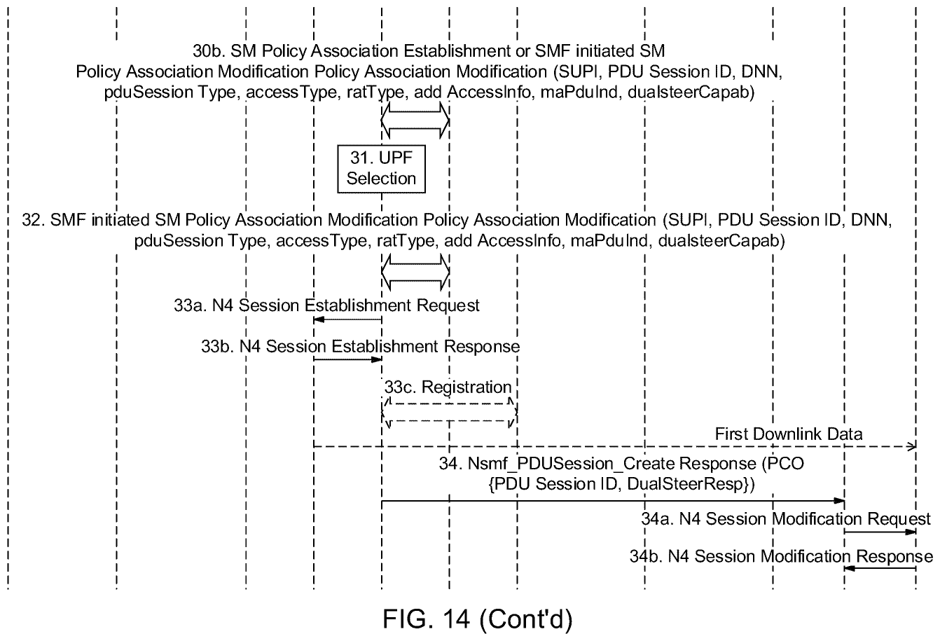

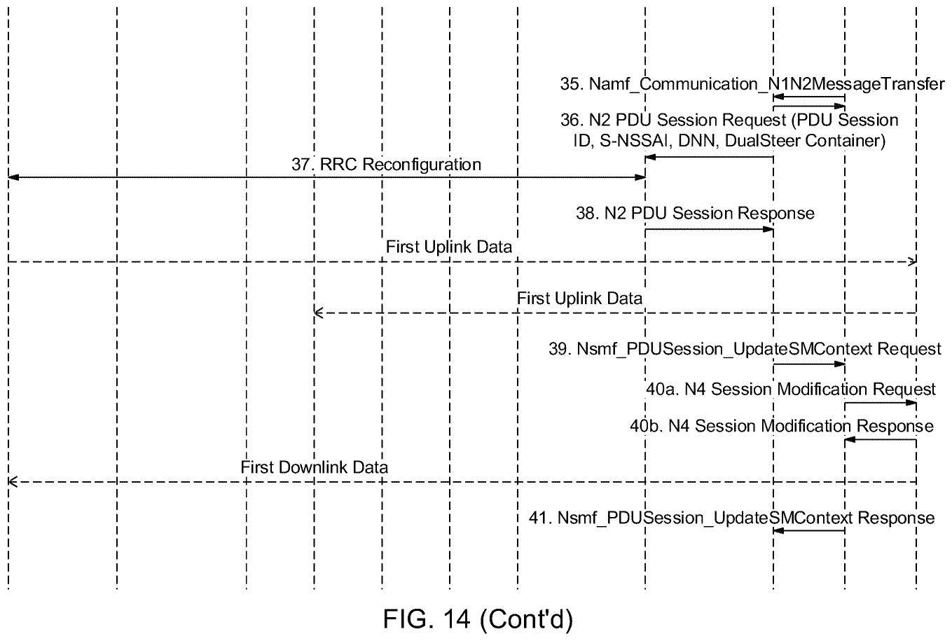

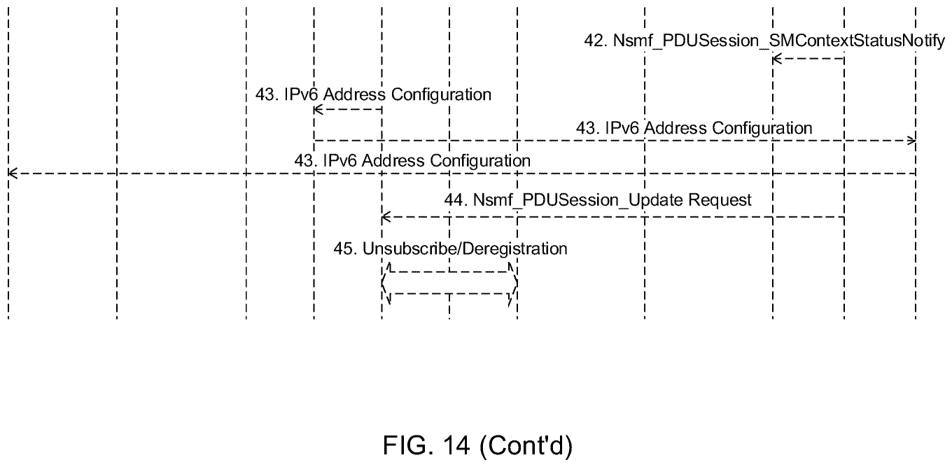

FIG. 14 illustrates an example of a UE requested PDU session establishment procedure for a DualSteer UE with simultaneous access to two 3GPP networks, using different PLMNs. As shown in an example in FIG. 14, a DualSteer UE 1402 may access two 3GPP networks using different PLMNs, a HPLMN and a VPLMN. The HPLMN includes a RAN A 5G NR node 1403, an AMF 1408, a PSA H-UPF 1440, an H-SMF 1410, a PCF 1420 and a UDM 1460. Also, the VPLMN includes a RAN B 5G NR node 1404, an AMF 1409, a V-SMF 1430 and a V-UPF 1450.

The example procedure in FIG. 14 assumes the DualSteer UE 1402 first selects the HPLMN access to initiate the UE-requested PDU session establishment procedure. The UE-requested PDU session establishment procedure on the HPLMN will be as defined in 3GPP TS 23.502 clause 4.3.2.2.1. The UE-requested PDU session establishment procedure on the VPLMN will be as defined in 3GPP TS 23.502 clause 4.3.2.2.2. The procedure assumes that the DualSteer UE 1402 has already registered on the AMFs 1408, 1409 in both 3GPP networks; thus, unless the UE is Emergency Registered, the AMFs 1408, 1409 have already retrieved the user subscription data from the UDM 1460. This may registration may be represented by step 0 in FIG. 14. Below are a few example aspects that will differ from the current defined procedures in 3GPP TS 23.502 clause 4.3.2.2.1 and 4.3.2.2.2.

In an example shown in FIG. 14, the DualSteer UE 1402 will include the PDU Session ID and the DualSteer request within the PDU Session Establishment Request and the CreateSMcontext Request message (indicating the support for DualSteer features) to the AMF 1408 and H-SMF 1410 in Steps 1 and 3, and to the AMF 1409 and V-SMF 1430 in 22 and 24a.

If the H-SMF 1410 supports the DualSteer features, it will include the PDU Session ID and the DualSteer response (indicating the support for DualSteer features) in a message to the UE 1402 via AMF in Step 5. Similarly, the V-SMF 1430 will include the PDU Session ID and the DualSteer response (indicating the support for DualSteer features) in a message to the AMF 1409 in Step 24b.

The H-SMF 1410 may perform an SM Policy Association Establishment procedure to establish an SM Policy Association with the PCF 1420 in the home network (HPLMN) and get the default PCC Rules for the PDU Session. This association will consider the DualSteer feature support and any associated polices in Steps 7b and 32.

The N2 PDU Session Request in step 12 and 38, the PDU Session Establishment Accept message in step 13 and the RRC Reconfiguration message in step 37 will contain the DualSteer Container IE for the DualSteer UE 1402 from the SMF for parameters associated with DualSteer.

Examples are provided herein of a UE requested PDU session establishment procedure for a DualSteer UE with simultaneous access to two 3GPP networks, using the same PLMN. In the case of the same PLMN, the PDU Session Establishment procedure will be initiated by the DualSteer UE. Over which 3GPP access to initiate the UE-requested PDU session establishment procedure is UE implementation specific.

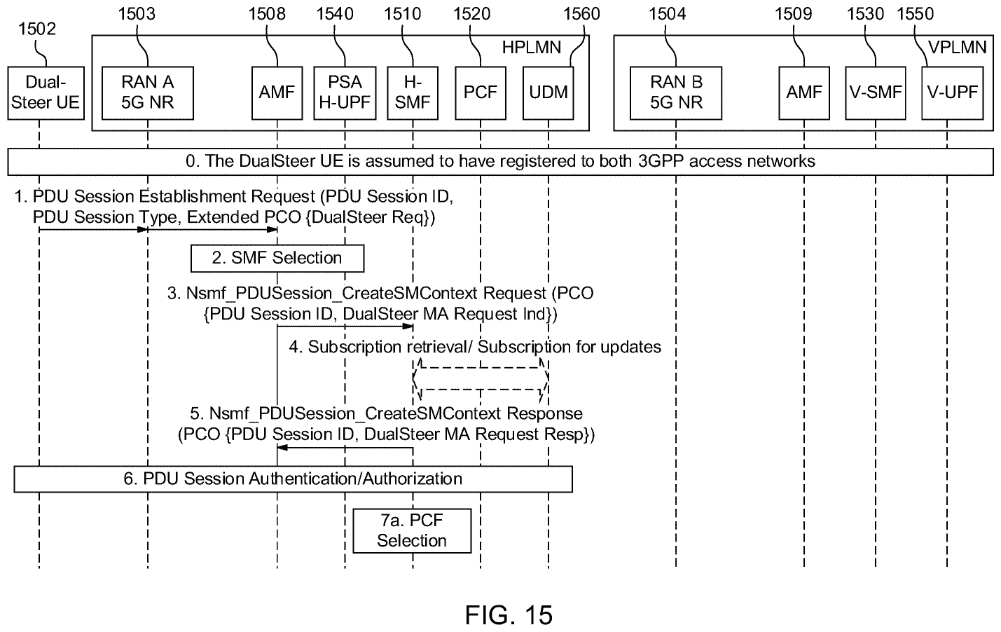

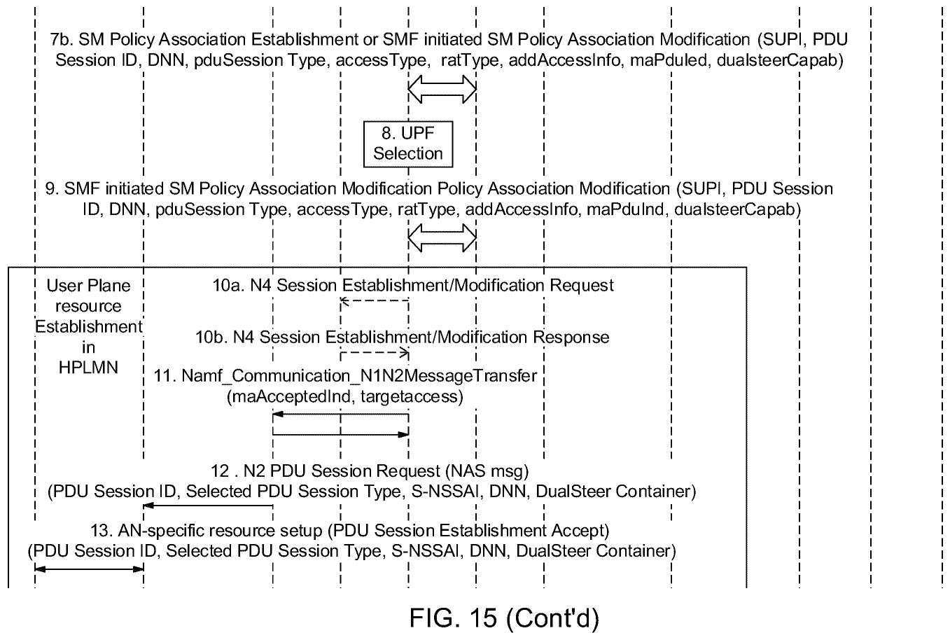

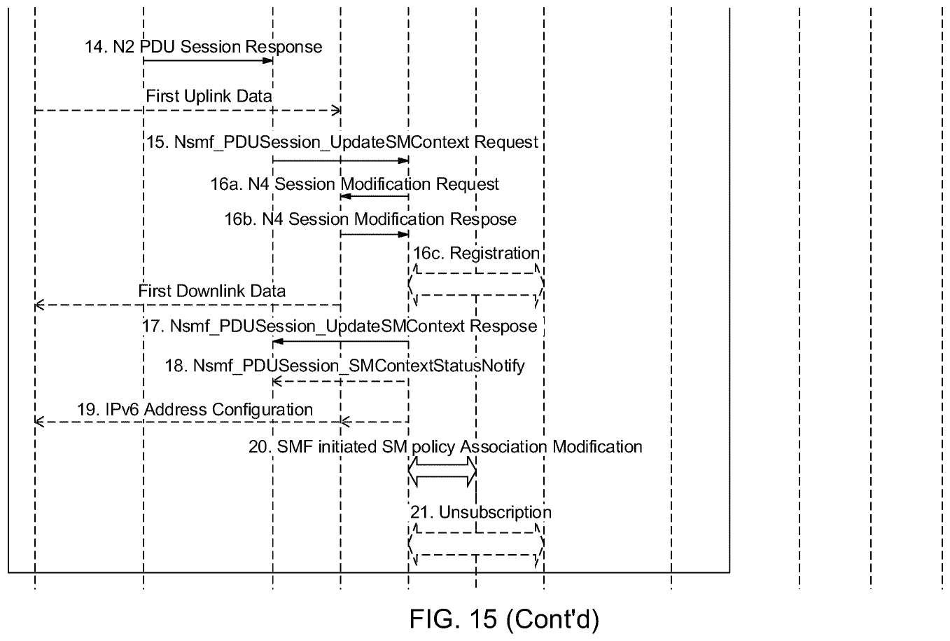

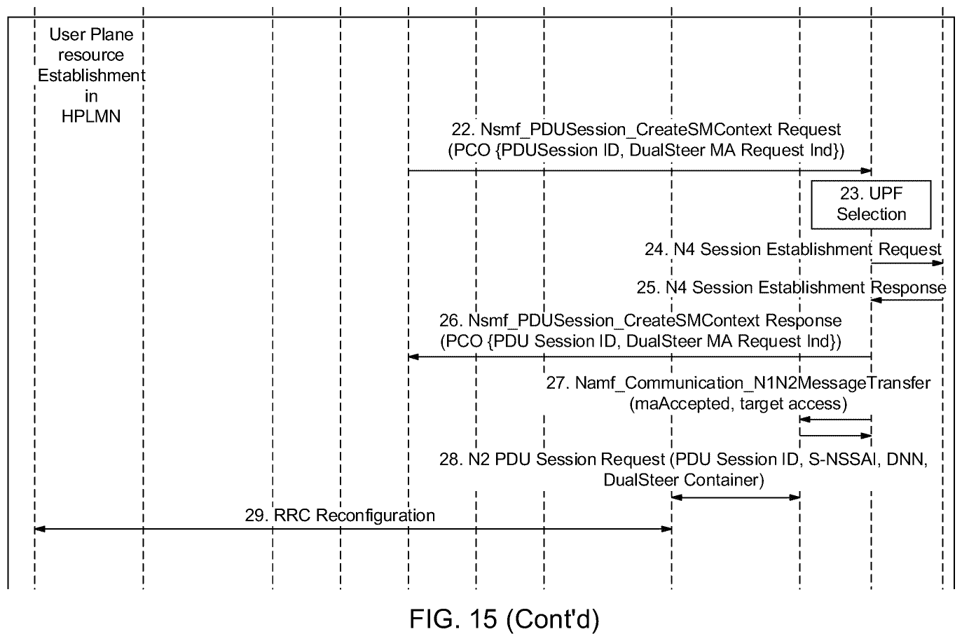

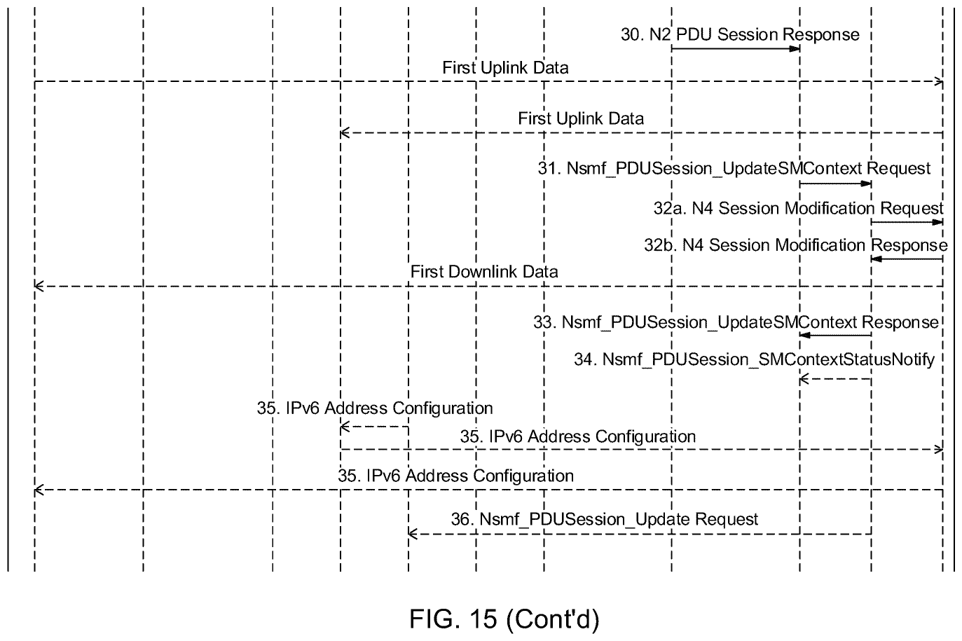

FIG. 15 illustrates an example of a UE requested PDU session establishment procedure for a DualSteer UE with simultaneous access to two 3GPP networks, using the same PLMN. As shown in an example in FIG. 14, the HPLMN includes a RAN A 5G NR node 1503, an AMF 1508, a PSA H-UPF 1540, an H-SMF 1510, a PCF 1520 and a UDM 1560. Also, the VPLMN includes a RAN B 5G NR node 1504, an AMF 1509, a V-SMF 1530 and a V-UPF 1550.

The example procedure in FIG. 15 assumes the DualSteer UE 1502 first selects the HPLMN access to initiate the UE-requested PDU session establishment procedure. The UE-requested PDU session establishment procedures will be as defined in 3GPP TS 23.502 clause 4.3.2.2.1 and clause 4.3.2.2.2. The procedure assumes that the UE 1502 has already registered on the AMFs in both 3GPP networks; thus, unless the UE 1502 is Emergency Registered, the AMFs have already retrieved the user subscription data from the UDM 1560. This may registration may be represented by step 0 in FIG. 15. Below are a few example aspects that will differ from the current defined procedures in 3GPP TS 23.502 clause 4.3.2.2.1 and 4.3.2.2.2.

The DualSteer UE 1502 will include the PDU Session ID and the DualSteer request within the PDU Session Establishment Request and the CreateSMcontext Request message (indicating the support for DualSteer features) to the AMF 1508 and H-SMF 1510 in Steps 1 and 3.

If the H-SMF 1510 supports the DualSteer features, it will include the PDU Session ID and the DualSteer response (indicating the support for DualSteer features) to the AMF 1508 in Step 5 (and similarly to the AMF 1509, via the V-SMF 1530 in Steps 22 and 27).

The H-SMF 1510 may perform an SM Policy Association Establishment procedure to establish an SM Policy Association with the PCF 1520 in the home network (HPLMN) and get the default PCC Rules for the PDU Session. This association will consider the DualSteer feature support and any associated polices in Steps 7b.

Further, the N2 PDU Session Request in step 12 and 28, the PDU Session Establishment Accept message in step 13 and the RRC Reconfiguration message in step 29 will contain the DualSteer Container IE for the DualSteer UE 1502 from the SMF for parameters associated with DualSteer.

In other examples, the procedures that apply to the same PLMN scenario with an HPLMN and a VPLMN apply equally to a scenario with two networks. For example, the procedure and steps shown in FIG. 15 for an HPLMN and a VPLMN apply equally to a network A and a network B in the same PLMN. Also, network A may be an anchoring network and network B may be a non-anchoring network. Further, the PLMN value may be the same for both network A and network B. More specifically, a PSA UPF A in network A may perform the same steps as the PSA H-UPF 1540 in the HPLMN of FIG. 15. Similarly, an SMF A in network A may perform the same steps as the H-SMF 1510 in the HPLMN of FIG. 15. Likewise, an SMF B in network B may perform the same steps as the V-SMF 1530 in the VPLMN of FIG. 15. Moreover, a UPF B in network B may perform the same steps as the V-UPF 1550 in the VPLMN of FIG. 15.

Further, in an example, network A and network B may use the communication system architecture as shown in the example in FIG. 11. As noted, network A may be an anchoring network and network B may be a non-anchoring network. More specifically, a PSA UPF A in network A may perform the same steps as the H-UPF 1140, which may be a PSA UPF, in the HPLMN of FIG. 11. Similarly, an SMF A in network A may perform the same steps as the H-SMF 1110 in the HPLMN of FIG. 11. Likewise, an SMF B in network B may perform the same steps as the V-SMF 1130 in the VPLMN of FIG. 11. Moreover, a UPF B in network B may perform the same steps as the V-UPF 1150 in the VPLMN of FIG. 15. Further, the inter-PLMN interfaces of FIG. 11 may be intra-PLMN interfaces in the example of network A and network B. For example, an N16 link between SMF A and SMF B may be an intra-PLMN interface. Similarly, an N9 link between UPF A and UPF B may be an intra-PLMN interface.

In an example, a UE transmits first information indicating that the UE requests access to two 3GPP access networks simultaneously and that the UE supports access to two 3GPP access networks simultaneously. Further, the UE receives second information indicating rules for accessing the two 3GPP access networks simultaneously.

Moreover, the UE transmits data using an MA PDU session based on the rules for accessing the two 3GPP access networks simultaneously, where the MA PDU session is established on a first 3GPP access network and a second 3GPP access network. Additionally or alternatively, the first information is included in a PDU session establishment request message. Additionally or alternatively, the second information is included in a PDU session establishment accept message. Additionally or alternatively, the UE is a DualSteer UE.

In an example, the first information includes a DualSteer request, and the second information includes a DualSteer container IE. Additionally or alternatively, the DualSteer container IE includes DualSteer parameters.

Additionally or alternatively, the first information includes DualSteer indication information and DualSteer capability information. Additionally or alternatively, the second information includes the DualSteer indication information and DualSteer traffic rules information.

Additionally or alternatively, the UE is registered over the first 3GPP access network and the second 3GPP access network in the same PLMN. Additionally or alternatively, the UE is registered over the first 3GPP access network and the second 3GPP access network in different PLMNs. Additionally or alternatively, the UE is registered over the first 3GPP access network or the second 3GPP access network in a PLMN.

In another example, a network node receives first information indicating that a UE requests access to two 3GPP access networks simultaneously and that the UE supports access to two 3GPP access networks simultaneously. Further, the network node sends second information indicating rules for accessing the two 3GPP access networks simultaneously. Also, the network node receives data using an MA PDU session based on the rules for accessing the two 3GPP access networks simultaneously, where the MA PDU session is established on a first 3GPP access network and a second 3GPP access network.

In an example, the network node includes an AMF. Additionally or alternatively, the network node includes an SMF.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a user equipment (UE), the method comprising:
transmitting first information indicating that the UE requests access to two Third Generation Partnership Project (3GPP) access networks simultaneously and that the UE supports access to two 3GPP access networks simultaneously;
receiving second information indicating rules for accessing the two 3GPP access networks simultaneously; and
transmitting data using a multi-access (MA) protocol data unit (PDU) session based on the rules for accessing the two 3GPP access networks simultaneously, wherein the MA PDU session is established on a first 3GPP access network and a second 3GPP access network.

2. The method of claim 1, wherein the first information is included in a PDU session establishment request message, and the second information is included in a PDU session establishment accept message.

3. The method of claim 1, wherein the UE is a Dualsteer UE.

4. The method of claim 1, wherein the first information includes a DualSteer request, and the second information includes a DualSteer container information element (IE), wherein the DualSteer container IE includes DualSteer parameters.

5. The method of claim 1, wherein the first information includes DualSteer indication information and DualSteer capability information, and the second information includes the DualSteer indication information and DualSteer traffic rules information.

6. The method of claim 1, wherein the UE is registered over the first 3GPP access network and the second 3GPP access network in the same public land mobile network (PLMN).

7. The method of claim 1, wherein the UE is registered over the first 3GPP access network and the second 3GPP access network in different PLMNs.

8. The method of claim 1, wherein the UE is registered over the first 3GPP access network or the second 3GPP access network in a PLMN.

9. A user equipment (UE) comprising;
a transceiver; and
a processor operatively coupled to the transceiver; wherein:
the transceiver and the processor are configured to transmit first information indicating that the UE requests access to two Third Generation Partnership Project (3GPP) access networks simultaneously and that the UE supports access to two 3GPP access networks simultaneously;
the transceiver is configured to receive second information indicating rules for accessing the two 3GPP access networks simultaneously; and
the transceiver and the processor are configured to transmit data using a multi-access (MA) protocol data unit (PDU) session based on the rules for accessing the two 3GPP access networks simultaneously, wherein the MA PDU session is established on a first 3GPP access network and a second 3GPP access network.

10. The UE of claim 9, wherein the first information is included in a PDU session establishment request message, and the second information is included in a PDU session establishment accept message.

11. The UE of claim 9, wherein the UE is a Dualsteer UE.

12. The UE of claim 9, wherein the first information includes a DualSteer request, and the second information includes a DualSteer container information element (IE), wherein the DualSteer container IE includes DualSteer parameters.

13. The UE of claim 9, wherein the first information includes DualSteer indication information and DualSteer capability information, and the second information includes the DualSteer indication information and DualSteer traffic rules information.

14. The UE of claim 9, wherein the UE is registered over the first 3GPP access network and the second 3GPP access network in the same public land mobile network (PLMN).

15. The UE of claim 9, wherein the UE is registered over the first 3GPP access network and the second 3GPP access network in different PLMNs.

16. The UE of claim 9, wherein the UE is registered over the first 3GPP access network or the second 3GPP access network in a PLMN.

17. A network node comprising:
a transceiver; and
a processor operatively coupled to the transceiver; wherein:
the transceiver is configured to receive first information indicating that a user equipment (UE) requests access to two Third Generation Partnership Project (3GPP) access networks simultaneously and that the UE supports access to two 3GPP access networks simultaneously;
the transceiver and the processor are configured to send second information indicating rules for accessing the two 3GPP access networks simultaneously; and
the transceiver is configured to receive data using a multi-access (MA) protocol data unit (PDU) session based on the rules for accessing the two 3GPP access networks simultaneously, wherein the MA PDU session is established on a first 3GPP access network and a second 3GPP access network.

18. The network node of claim 17, wherein the UE is a Dualsteer UE, the first information includes a DualSteer request, and the second information includes a DualSteer container information element (IE), wherein the DualSteer container IE includes DualSteer parameters.

19. The network node of claim 17, wherein the first information includes DualSteer indication information and DualSteer capability information, and the second information includes the DualSteer indication information and DualSteer traffic rules information.

20. The network node of claim 17, wherein the network node includes one or more of an Access and Mobility Management Function (AMF), and a Session Management Function (SMF).
